(19) United States
(12) Patent Application Publication
(10) Pub. No.: US 2006/0241826 A1
(43) Pub. Date: Oct. 26, 2006

(54) Onboard battery control device and control method

(75) Inventors: Teruo Ishishita, Nishikamo-gun, Aichi-KEN (JP); Hidenori Takahashi, Okazaki-shi, Aichi-ken (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-ken (JP)

(21) Appl. No.: 10/555,992

(22) PCT Filed: Apr. 28, 2004
(86) PCT No.: PCT/JP04/06230

§ 371 Date: Nov. 8, 2005

(30) Foreign Application Priority Data
Jun. 3, 2003 (JP) 2003-157702

(51) Int. Cl. G06F 17/00

(52) U.S. Cl. 701/22; 180/65.2

(57) ABSTRACT

A hybrid ECU sets a charge power limit value W (IN) and a discharge power limit value W (OUT) that are respective limits of electric power to charge a battery and electric power to be discharged therefrom. The charge power limit value W (IN) and the discharge power limit value W (OUT) are set in such a manner that, in a case where warm-up of a catalyst is necessary, charging and discharging of the battery is permitted even if the battery temperature TB is higher as compared with that in a case where warm-up of the catalyst is unnecessary. Thus, if warm-up of the catalyst is necessary, the limitation on the charge/discharge electric power are relaxed with respect to the battery temperature so as to increase the chargeable/dischargeable temperature region for the battery. In this way, a motor generator can be driven while the battery temperature is high.

### TECHNICAL FIELD

The present invention relates to a control device and a control method for an onboard battery. In particular, the present invention relates to a control device and a control method for a battery mounted on a vehicle on which mounted such an engine as internal combustion engine and such a motor as electric rotating machine and which runs by a driving force supplied from at least one of the engine and motor.

### BACKGROUND ART

A hybrid vehicle runs by a driving force from at least one of such an engine as internal combustion engine and such a motor as electric rotating machine. The engine and motor of the hybrid vehicle are selectively used according to the running state of the vehicle for making effective use of respective features of the engine and motor. As compared with vehicles running with the engine only, the hybrid vehicle generally consumes less fuel and emits less exhaust gas.

The hybrid vehicle, however, still emits the exhaust gas since fuel is burned for driving the engine. A catalyst is thus necessary for purifying the exhaust gas. In order to allow the catalyst to satisfactorily purify the exhaust gas, the catalyst should sufficiently be heated. For example, it is known that warm-up is necessary for raising the temperature of the catalyst when the engine having been stopped for a long period of time is started.

Japanese Patent Laying-Open No. 2000-110604 discloses a vehicle battery control device that can warm up a catalyst for purifying exhaust gas without deteriorating fuel efficiency. This battery control device includes a battery charge detection unit for detecting the state of charge (SOC) of a secondary battery, a power demand setting unit for setting a power demand on an engine based on predetermined parameters including the detected SOC, and an engine control unit for controlling the engine in such a manner that output power of the engine is almost equal to the set power demand. The power demand setting unit sets the power demand to a value which is greater than that for a normal operation if a warm-up request is made for the purpose of increasing the temperature of the catalyst under the condition that the detected SOC falls within a predetermined range.

With this battery control device, the SOC of the secondary battery is detected and, if a warm-up request is made for raising the temperature of the catalyst under the condition that the SOC is within a predetermined range, power of an amount that is enough to charge the secondary battery and that is greater than power in a normal state is output from the engine. In this way, an appropriate amount of exhaust emissions from the engine can be secured. Then, the temperature of the catalyst in an exhaust passage of the engine can sufficiently be increased with the appropriately heated exhaust emissions, so that the catalyst can be warmed up in an optimal way. The greater power output from the engine is converted by a motor generator into an electric power for charging the secondary battery. Therefore, no energy loss occurs and deterioration of the fuel efficiency can be prevented.

With the battery control device disclosed in the above-referenced publication, the SOC of the secondary battery is detected, an amount of power greater than that in a normal state is set as the power demand if a warm-up request is made for increasing the temperature of the catalyst under the condition that the SOC falls within a predetermined range. More specifically, two different maps are stored that define charge demands on the SOC of the secondary battery. On a warm-up request, one of the maps is employed that defines charge demands on the SOC that are higher than those of the map employed when no warm-up request is given. In this case where the warm-up operation is necessary, it is impossible, at the start for example of the engine having been stopped for a long period of time, that the SOC of the secondary battery is high enough to be included in a request-to-discharge region on this map employed in the warm-up operation, and thus the SOC of the secondary battery at this time is usually in a request-to-charge region on the map. In this state, if a driver requests acceleration by stepping on the accelerator for example, no electric power is discharged from the secondary battery due to the high charge demand of the secondary battery. No electric power is then supplied from the battery to the motor generator functioning as a motor so that the vehicle cannot be driven by the motor.

In other words, all the necessary power for acceleration of the vehicle is supplied from the engine. In addition, although Japanese Patent Laying-Open No. 2000-110604 does not explicitly disclose, the engine could increase its output for satisfying the acceleration demand and still increase the output for allowing the motor generator to produce electric power. When the engine output thus increases for satisfying the acceleration demand by the driver, a large amount of exhaust gas is accordingly generated even in the warm-up operation. Then, in the state where the catalyst temperature does not sufficiently increase so that the catalyst cannot fully exhibit its purifying ability, an amount of exhaust gas that cannot be purified by the catalyst being warmed up is generated. A resultant problem is that unpurified exhaust gas could be discharged.

### DISCLOSURE OF THE INVENTION

An object of the present invention is to provide a battery control device and a battery control method for a vehicle with which the vehicle can sufficiently be accelerated even in a warm-up operation for activating a catalyst while unpurified exhaust gas is prevented from being discharged.

Another object of the present invention is to provide a battery control device and a battery control method for a vehicle with which the vehicle can be run by a driving force from an electric motor in such a manner that shortening of the battery life is suppressed in a case where warm-up of a catalyst is unnecessary while priority is given to driving of the electric motor over an increase in load on the battery in a case where warm-up of the catalyst is necessary.

Still another object of the present invention is to provide a battery control device and a battery control method for a vehicle with which the electric motor can be driven regardless of whether the temperature of the battery is high or low.

A further object of the present invention is to provide a battery control device and a battery control method for a vehicle with which deterioration of the battery due to an excessive temperature increase can be prevented.

According to an aspect of the present invention, a battery control device controls a battery mounted on a vehicle having an engine generating a driving force by combustion of fuel, a catalyst purifying exhaust gas generated by the combustion, an electric motor generating a driving force, and the battery supplying electric power to the electric motor. The vehicle runs by at least one of respective driving forces from the engine and the electric motor. The control device includes an acceleration request detection unit for detecting an acceleration request of the vehicle, a determination unit for determining whether or not warm-up for increasing the temperature of the catalyst is necessary, and a control unit for controlling, in a case where the determination unit determines that the warm-up is necessary and the acceleration request is detected, charge/discharge electric power of the battery to drive the vehicle by the electric motor.

According to the present invention, the acceleration request detection unit detects an acceleration request of the vehicle and the determination unit determines whether warm-up of the catalyst is necessary or not. The control unit controls, in a case where it is determined that the warm-up is necessary and the acceleration request is detected, charge/discharge electric power of the battery in a manner that the vehicle is driven by the electric motor and accordingly the acceleration request is fulfilled. More specifically, rather than driving of the vehicle by the engine (or in addition to driving of the vehicle by the engine), driving of the vehicle by the electric motor is effected by increasing a dischargeable region to use resultant electric power discharged from the battery regardless of the state of the battery. Thus, upon an acceleration request made while the catalyst is being warmed up, the electric motor is driven to supplement motive power, thereby suppressing an increase of the engine output so as not to allow the engine output to reach a level higher than necessary (higher than the level necessary for warming up the catalyst) and avoiding emission of exhaust gas of an amount larger than an amount that can be purified by the catalyst being warmed up. The battery control device can thus be provided with which the vehicle can sufficiently be accelerated even in the warm-up operation and unpurified exhaust gas can be prevented from being discharged.

Preferably, the control unit includes a limitation unit for limiting the charge/discharge electric power of the battery, and a relaxation unit for relaxing, if the determination unit determines that the warm-up is necessary, limitation on the charge/discharge electric power as compared with limitation on the charge/discharge electric power in a case where the warm-up is unnecessary.

According to the present invention, the control unit limits the charge/discharge electric power of the battery for the purpose of protecting the battery while the relaxation unit relaxes the limitation on the charge/discharge electric power, particularly the discharge electric power, upon an acceleration request in the warm-up operation, as compared with charge/discharge electric power in a case where the warm-up is unnecessary. In this way, even if the SOC is in a region where discharge does not usually occur, electric power is supplied from the battery to the electric motor to address the acceleration request without increase in exhaust gas from the engine. If the warm-up is unnecessary, the charge/discharge electric power can be limited to protect the battery against a shortened battery life for example due to excessive charging/discharging of the battery. In other words, if the warm-up is necessary, the limitation on the discharge is relaxed while the charging/discharging of the battery can appropriately be limited if the warm-up is unnecessary. In this way, the battery control device for the vehicle can be provided with which shortening of the battery life is suppressed in a case where warm-up of the catalyst is unnecessary while priority is given to driving of the electric motor over increase in load on the battery in a case where warm-up of the catalyst is necessary, so as to allow the vehicle to run by the driving force from the electric motor.

More preferably, the battery control device includes a temperature detection unit for detecting the temperature of the battery. The limitation unit limits the charge/discharge electric power based on the detected temperature.

According to the present invention, the temperature detection unit detects the temperature of the battery and the limitation unit limits the charge/discharge electric power based on the detected temperature. The charge/discharge electric power can thus be limited appropriately according to the battery temperature. Then, a temperature region where charging/discharging of the battery can be done may be defined for example and, if the battery temperature is out of this temperature region, the charging/discharging can be stopped to prevent degradation of the battery.

Still more preferably, the relaxation unit relaxes the limitation on the charge/discharge electric power based on the battery temperature if it is determined that the warm-up is necessary.

According to the present invention, the relaxation unit relaxes the limitation on the charge/discharge electric power based on the battery temperature if it is determined that the warm-up is necessary. Thus, if the warm-up is necessary, the limitation on the charge/discharge electric power based on the battery temperature can be relaxed. Accordingly, the battery control device for the vehicle can be provided with which the chargeable/dischargeable region of the battery can be expanded for example in a case where the warm-up is necessary as compared with that in a case where the warm-up is unnecessary, so that the electric motor can be driven regardless of whether the battery is in a higher or lower temperature state.

Still more preferably, the battery control device further includes an increment detection unit for detecting an increment in temperature of the battery. The limitation unit limits the charge/discharge electric power based on the detected increment.

According to the present invention, the increment detection unit detects an increment in battery temperature, and the control unit limits the charge/discharge electric power based on the detected increment. The charge/discharge electric power can thus be limited according to the increment in temperature. Accordingly, the battery control device for the vehicle can be provided with which charging/discharging of the battery is stopped if any excessive temperature increment that can be regarded as an abnormality of the battery is detected so as to prevent degradation of the battery due to the excessive temperature increment.

According to another aspect of the present invention, a battery control method is a method of controlling a battery mounted on a vehicle having an engine generating a driving force by combustion of fuel a catalyst purifying exhaust gas generated by the combustion, an electric motor generating a driving force, and the battery supplying electric power to the electric motor. The vehicle runs by at least one of respective driving forces from the engine and the electric motor. The battery control method includes the steps of detecting an acceleration request of the vehicle, determining whether or not warm-up for increasing the temperature of the catalyst is necessary, and controlling, in a case where it is determined that the warm-up is necessary in the determining step and the acceleration request is detected, charge/discharge electric power of the battery to drive the vehicle by the electric motor.

According to the present invention, in the step of detecting an acceleration request of the vehicle, the acceleration request of the vehicle is detected and, in the step of determining whether or not warm-up is necessary, it is determined whether the warm-up is necessary or not. Further, in the step of controlling charge/discharge electric power of the battery, if it is determined that warm-up of the catalyst is necessary and the acceleration request is detected, the charge/discharge electric power of the battery is controlled in a manner that the vehicle is driven by the electric motor. More specifically, rather than driving of the vehicle by the engine (or in addition to driving of the vehicle by the engine), driving of the vehicle by the electric motor is effected with electric power discharged from the battery regardless of the state of the battery so long as the battery can discharge the power. Thus, upon an acceleration request in the catalyst warm-up operation, the electric motor is driven to supplement motive power, thereby suppressing an increase of the engine output so as not to allow the engine output to reach a level higher than necessary (higher than the level necessary for warming up the catalyst) and avoiding emission of exhaust gas of an amount larger than an amount that can be purified by the catalyst being warmed up. The battery control method can thus be provided with which the vehicle can sufficiently be accelerated even in the warm-up operation and unpurified exhaust gas can be prevented from being discharged.

### BRIEF DESCRIPTION OF THE DRAWINGS

FIG. 1 shows the whole of a power unit of a vehicle according to an embodiment of the present invention.

FIG. 2 partially shows the power unit of the vehicle according to the embodiment of the present invention.

FIGS. 3A and 3B show respective maps used for calculating SW (IN) and SW (OUT).

FIG. 4 shows a map used for calculating ηW (IN).

FIGS. 5A and 5B show respective maps used for calculating HW (IN) and HW (OUT) in a case where warm-up of a catalyst is unnecessary.

FIGS. 6A and 6B show respective maps used for calculating HW (IN) and HW (OUT) in a case where warm-up of the catalyst is necessary.

FIG. 7 is a flowchart showing a control structure of a program executed by a hybrid ECU according to the embodiment of the present invention.

FIG. 8 is a flowchart showing a control structure of a subroutine for calculating SW (IN) and SW (OUT).

FIG. 9 is a flowchart showing a control structure of a subroutine for calculating ηW (IN).

FIG. 10 is a flowchart showing a control structure of a subroutine for calculating HW (IN) and HW (OUT).

FIGS. 11A and 11B show W (IN) and W (OUT) with respect to battery temperature TB.

### BEST MODES FOR CARRYING OUT THE INVENTION

Embodiments of the present invention are hereinafter described with reference to the drawings. Here, like components are denoted by like reference characters, called by the same name and function in the same manner, and thus a detailed description thereof will not be repeated.

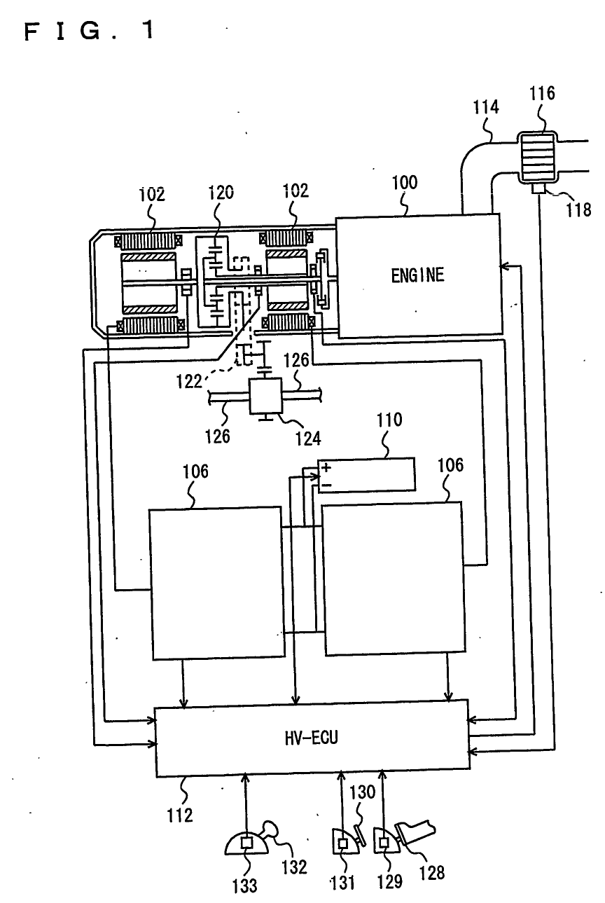

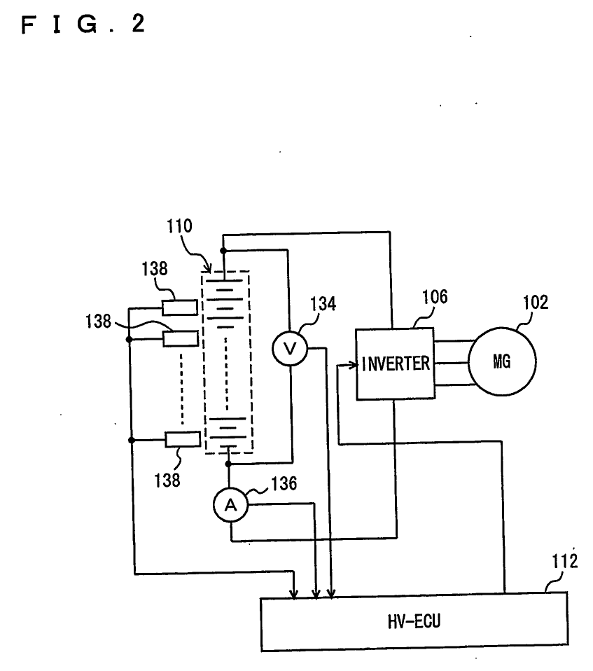

Referring to FIGS. 1 and 2, a description is given of a power unit of a vehicle that includes a hybrid ECU (Electronic Control Unit) 112 implementing a battery control device according to an embodiment of the present invention.

As shown in FIG. 1, the power unit includes an engine 100, a motor generator 102, an inverter 106 connected to motor generator 102, a battery 110 connected to inverter 106, and hybrid ECU 112 controlling engine 100 and inverter 106. To hybrid ECU 112, engine 100, motor generator 102, inverter 106 and battery 110 are connected.

Engine 100 burns such a fossil fuel as gasoline to generate a driving force while emitting exhaust gas generated in the combustion process. The exhaust gas is then passed through an exhaust pipe 114 coupled to engine 100, purified by a catalyst 116 provided within exhaust pipe 114 and thereafter discharged from the vehicle to the outside.

Catalyst 116 oxidizes hydrocarbon and carbon monoxide into carbon dioxide and water while reducing nitrogen oxide. Catalyst 116 is a three-way catalyst. In order for catalyst 116 to effectively purify exhaust emissions, catalyst 116 should sufficiently be warmed. When engine 100 having been stopped for a long period of time is now started, the temperature of catalyst 116 is accordingly low. Warm-up is then necessary for raising the temperature thereof. For the battery control device of this embodiment, whether or not the warm-up of catalyst 116 is necessary is determined in accordance with the temperature of the catalyst TC. For this purpose, a catalyst temperature sensor 118 is provided on exhaust pipe 114 to be located near catalyst 116. This catalyst temperature sensor 118 is connected to hybrid ECU 112 to transmit catalyst temperature TC in the form of a detection signal to hybrid ECU 112.

The determination as to whether or not the warm-up of catalyst 116 is necessary may alternatively be made by measuring the time passed from turning of an ignition switch (not shown) to the start position or the time passed from system start.

Motor generator 102 generates a driving force with electric power supplied from battery 110. If the vehicle is under regenerative control, motor generator 102 functions as an electric generator for converting kinetic energy of the vehicle into electric energy and thereby charging battery 110.

The driving forces that are output from engine 100 and motor generator 102 are input to a power split device 120 comprised of a planetary gear set and transmitted through a reduction gear 122, a differential gear 124 and a drive shaft 126 to wheels (not shown). If the vehicle is being slowed down, revolutions of the wheels are transmitted via drive shaft 126, differential gear 124, reduction gear 122 and power split device 120 to motor generator 102. Motor generator 102 is thus rotated to operate as an electric generator. Moreover, the driving force which is output from engine 100 may also be used to rotate motor generator 102 via power split device 120 and thereby generate electric power.

Inverter 106 converts the DC current supplied from battery 110 into AC current to drive motor generator 102. Inverter 106 further converts the AC current generated by motor generator 102 into DC current to charge battery 110.

Battery 110 is a secondary battery having series-connected battery modules each comprised of a plurality of storage cells. Battery 110 is controlled in such a manner that the charge electric power level and the discharge electric power level each fall within a limited range.

To hybrid ECU 112, an accelerator position sensor 129 for detecting the step-on amount of an accelerator pedal 128, a brake position sensor 131 for detecting the step-on amount of a brake pedal 130 and a shift position sensor 133 for detecting the shift position of a shift lever 132 are further connected.

Moreover, as shown in FIG. 2, a voltage sensor 134 for detecting the voltage value of battery 110, a current sensor 136 for detecting the current value thereof and a battery temperature sensor 138 for detecting the temperature thereof are connected to hybrid ECU 112.

Hybrid ECU 112 controls engine 100, motor generator 102, inverter 106 and battery 110 based on respective detection signals transmitted from the above-described sensors in such a manner that the vehicle runs upon an acceleration request from a driver. Hybrid ECU 112 also sets, based on the detected state of battery 110, a charge power limit value (hereinafter indicated by W (IN)) as well as a discharge power limit value (hereinafter indicated by W (OUT)) that are respective limits of electric power to charge battery 110 and electric power to be discharged from battery 110.

In order to set W (IN), hybrid ECU 112 calculates a first charge power limit value (hereinafter indicated by SW (IN)), a second charge power limit value (hereinafter indicated by ηW (IN)) and a third charge power limit value (hereinafter indicated by HW (IN)). The maximum one of SW (IN), ηW (IN) and HW (IN) is set as W (IN). Further, in order to set W (OUT), hybrid ECU 112 calculates a first discharge power limit value (hereinafter indicated by SW (OUT)) and a third discharge power limit value (hereinafter indicated by HW (OUT)). The minimum one of SW (OUT) and HW (OUT) is set as W (OUT).

In this embodiment, SW (IN), ηW (IN), HW (IN) and W (IN) are represented by negative values and SW (OUT), HW (OUT) and W (OUT) are represented by positive values.

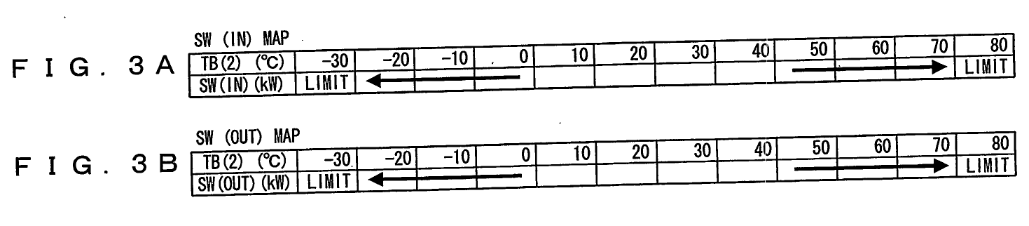

SW (IN) and SW (OUT) are each calculated on the basis of a battery voltage value V and a battery temperature TB according to a map stored in hybrid ECU 112. FIGS. 3A and 3B show respective maps for calculating SW (IN) and SW (OUT) with respect to a certain battery voltage value V. A plurality of maps similar to those in FIGS. 3A and 3B that are adapted for respective battery voltage values V are stored. According to these maps, SW (IN) and SW (OUT) are each set to a value correlated with battery voltage V and battery temperature TB. Referring to these maps, when battery temperature TB is 80° C. or −30° C., correlated SW (IN) and SW (OUT) are values limiting the charge electric power and the discharge electric power respectively so as to stop charging and discharging of battery 110. In this embodiment, SW (IN) is represented by a negative value and SW (OUT) is represented by a positive value.

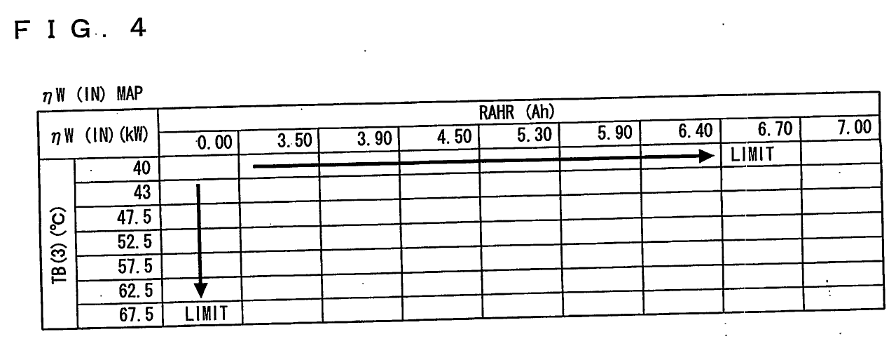

ηW (IN) is calculated based on a remaining capacity of the battery RAHR and a battery temperature TB according to a map stored in hybrid ECU 112. FIG. 4 shows a map for calculating ηW (IN). According to this map, ηW (IN) is set to a value correlated with battery temperature TB and remaining capacity of the battery RAHR. In this map, ηW (N) correlated with battery temperature TB of 67.5° C. and remaining battery capacity RAHR of 6.7 Ah is a value limiting charge electric power so as to stop charging of battery 110. In this embodiment, ηW (IN) is represented by a negative value.

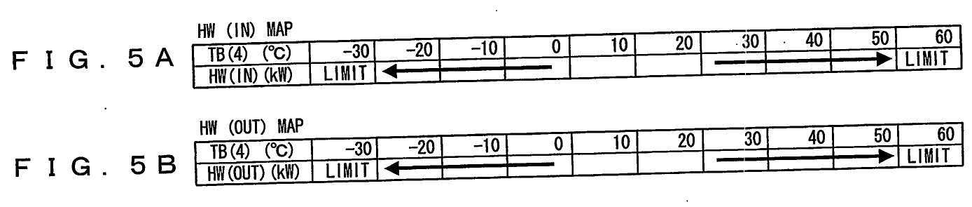

HW (IN) and HW (OUT) are calculated in different ways depending on whether warm-up of catalyst 116 is unnecessary or necessary. If warm-up of catalyst 116 is unnecessary, HW (IN) and HW (OUT) are calculated, as done for SW (IN) and SW (OUT), based on battery voltage value V and battery temperature TB according to maps stored in hybrid ECU 112. FIGS. 5A and 5B show respective maps for calculating HW (IN) and HW (OUT) with respect to a certain battery voltage V in a case where warm-up of catalyst 116 is unnecessary. A plurality of different maps adapted for respective battery voltage values V and similar to those maps shown in FIGS. 5A and 5B are stored. According to these maps, HW (IN) and HW (OUT) are each set to a value correlated with battery voltage V and battery temperature TB. In this map, when battery temperature TB is 60° C. or −30° C., HW (IN) and HW (OUT) are values limiting the charge/discharge electric power so as to stop charging/discharging of battery 110. In other words, HW (IN) and HW (OUT) are set in such a manner that the temperature at which charging/dicharging is limited by HW (IN) and HW (OUT) is lower than the temperature at which charging/discharging is limited by SW (IN) and SW (OUT).

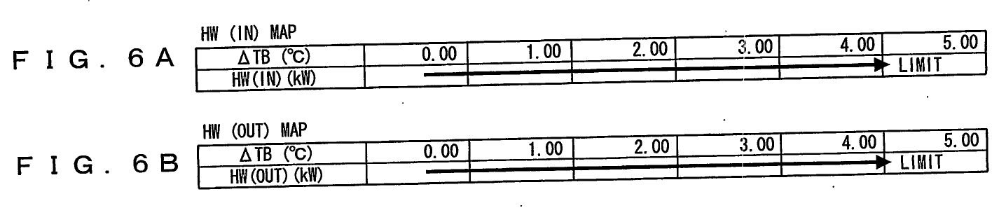

In a case where warm-up of catalyst 116 is necessary, HW (IN) and HW (OUT) are set based on an increment in battery temperature ATB which is a temperature increase from start of the engine, according to maps stored in hybrid ECU 112. FIGS. 6A and 6B show respective maps for calculating HW (IN) and HW (OUT) in a case where warm-up of catalyst 116 is required. According to these maps, HW (IN) and HW (OUT) are each set to a value correlated with a battery temperature increment ΔTB. In this map, if battery temperature increment ΔTB is 5° C., HW (IN) and HW (OUT) are respective values limiting the charge/discharge electric power so as to stop charging/discharging of battery 110. In this embodiment, HW (IN) is represented by a negative value and HW (OUT) is represented by a positive value.

The maps shown in FIGS. 3A-6B are exemplary ones and the present invention is not limited to these maps.

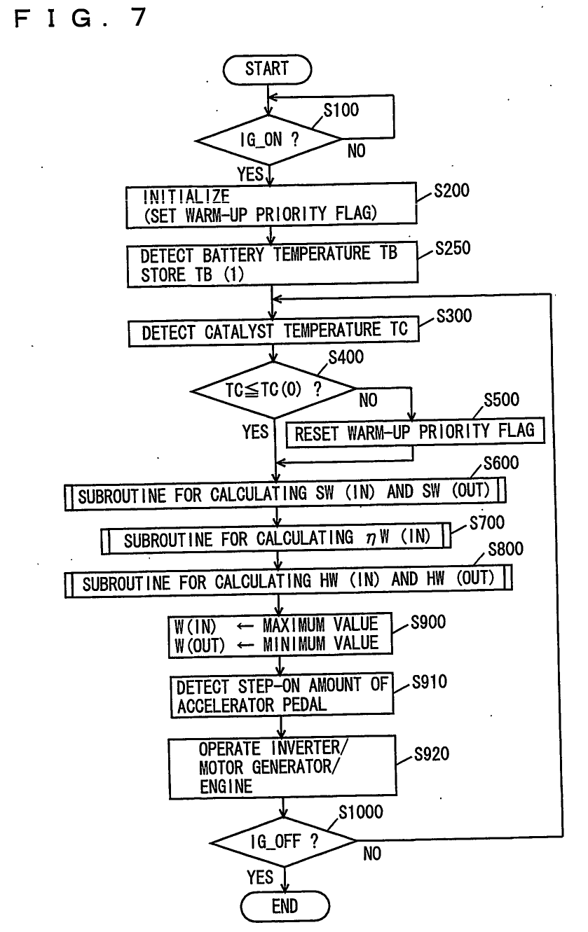

Referring to FIG. 7, a control structure of a program executed by hybrid ECU 112 is described.

In step (hereinafter abbreviated as S) 100, hybrid ECU 112 determines whether or not an ignition switch (not shown) is turned on. If the ignition switch is turned on (YES in S100), this control process proceeds to S200. If not (NO in S100), the process waits until the ignition switch is turned on.

In S200, hybrid ECU 112 initializes the system and sets a warm-up priority flag.

In S250, hybrid ECU 112 detects battery temperature TB and stores the detected battery temperature TB as an initial battery temperature TB (1). In S300, hybrid ECU 112 detects a catalyst temperature TC.

In S400, hybrid ECU 112 determines whether or not the detected catalyst temperature TC is at most (equal to or smaller than) a predetermined catalyst warm-up temperature TC (0). If catalyst temperature TC is at most catalyst warm-up temperature TC (0) (YES in S400), the process proceeds to S600. If not (NO in S400) the process proceeds to S500. In S500, hybrid ECU 112 resets the warm-up priority flag.

In S600, hybrid ECU 112 executes a subroutine for calculating SW (IN) and SW (OUT). In S700, hybrid ECU 112 executes a subroutine for calculating 11W (IN). In S800, hybrid ECU 112 executes a subroutine for calculating HW (IN) and HW (OUT). These subroutines (S600, S700, S800, S900) are hereinafter described in detail.

In S900, hybrid ECU 112 sets the maximum one of SW (IN), ηW (IN) and HW (IN) as W (IN). Hybrid ECU 112 further sets the minimum one of SW (OUT) and HW (OUT) as W (OUT).

In S910, hybrid ECU 112 detects the step-on amount of accelerator pedal 128. In S920, hybrid ECU 112 operates engine 100, motor generator 102 and inverter 106 according to the detected step-on amount in such a manner that prevents the charge/discharge electric power level of battery 110 from exceeding W (IN) and W (OUT).

In S1000, hybrid ECU 112 determines whether or not the ignition switch is turned off. If the ignition switch is turned off (YES in S1000), this process is completed. If not (NO in S1000), this process returns to S300.

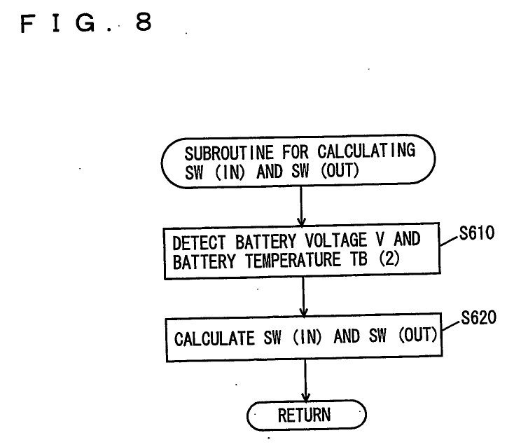

Referring to FIG. 8, a description is given of the subroutine for calculating SW (IN) and SW (OUT).

In S610, hybrid ECU 112 detects battery voltage V and battery temperature TB (2). In S620, hybrid ECU 112 calculates SW (IN) and SW (OUT) based on battery voltage V and battery temperature TB (2) according to the maps described with reference to FIGS. 3A and 3B.

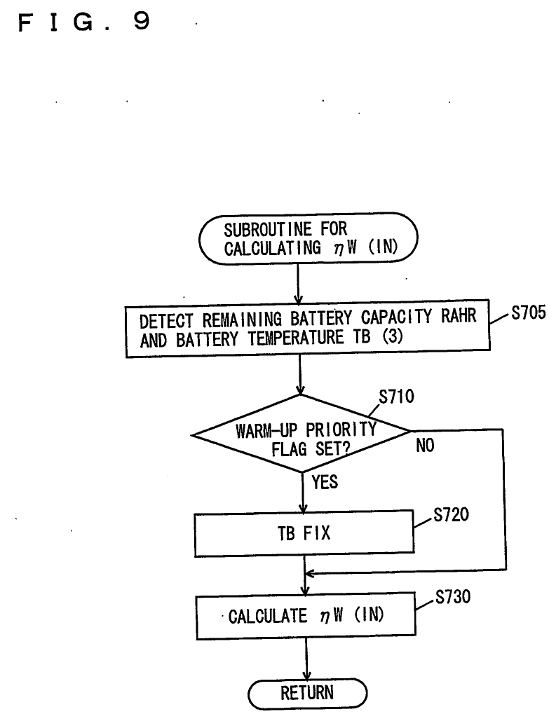

Referring to FIG. 9, the subroutine for calculating ηW (IN) is described.

In S705, hybrid ECU 112 detects remaining battery capacity RAHR and battery temperature TB (3). As to how to detect remaining battery capacity RAHR, any well-known technique like a generally-employed method of calculating the remaining capacity may be used and a detailed description thereof is not given here.

In S710 hybrid ECU 112 determines whether or not the warm-up priority flag is set. If the warm-up priority flag is set (YES in S710), the process proceeds to S720. If not (O in S710), the process proceeds to S730.

In S720, hybrid ECU 112 fixes battery temperature TB to a predetermined fixed value TB (0).

In S730, hybrid ECU 112 calculates ηW (IN) based on remaining battery capacity RAHR and battery temperature TB according to the above-described map in FIG. 4. At this time, if it is determined that warm-up is unnecessary, ηW (IN) is set to a value correlated with the detected battery temperature TB (3) and remaining battery capacity RAHEL. If it is determined that warm-up is necessary, ηW (IN) is set to a value, according to the map shown in FIG. 4, that is correlated with fixed value TB (0) and the detected remaining battery capacity RAHR while battery temperature TB is fixed at predetermined fixed value TB (0).

In this case, fixed value TB (0) is set to a value that does not cause ηW (IN) to limit charging/discharging of battery 110. More specifically, fixed value TB (0) is set to a value to allow ηW (IN) to be smaller than SW (IN) and ηW (IN). Since battery temperature TB is fixed at fixed value TB (0), ηW (IN) does not limit the charge/discharge electric power of battery 110 with respect to battery temperature TB.

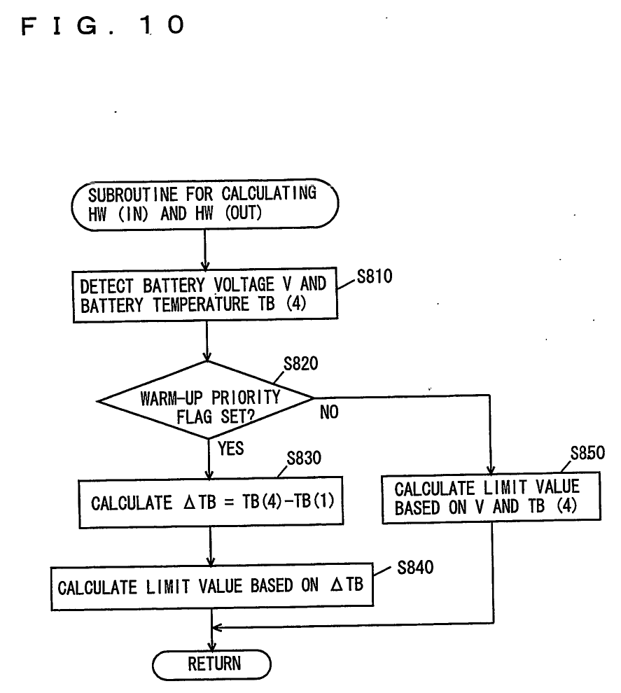

Referring to FIG. 10, the subroutine for calculating HW (IN) and HW (OUT) is described.

In S810, hybrid ECU 112 detects battery voltage V and battery temperature TB (4). In S820, hybrid ECU 112 determines whether or not the warm-up priority flag is set. If the warm-up priority flag is set (YES in S820), this process proceeds to S830. If not (NO in S820), the process proceeds to S850.

In S830, hybrid ECU 112 calculates battery temperature increment ΔTB from the difference between battery temperature TB (4) detected in S810 and initial battery temperature TB (1) stored in S250.

In S840, hybrid ECU 112 calculates HW (IN) and HW (OUT) based on the calculated battery temperature increment ΔTB according to the above-described maps shown respectively in FIGS. 6A and 6B. Here, HW (IN) and HW (OUT) are calculated based on battery temperature increment ΔTB without depending on battery temperature TB. Therefore, the charge/discharge electric power of battery 110 is not limited in connection with battery temperature TB itself.

In S850, hybrid ECU 112 calculates HW (IN) and HW (OUT) based on battery voltage V and battery temperature TB (4) detected in S810 according to the above-described maps shown in FIGS. 5A and 5B respectively. Here, HW (IN) and HW (OUT) are set in such a manner that the temperature at which charging/discharging is limited by HW (IN) and HW (OUT) is lower than the temperature at which charging/discharging is limited by SW (IN) and SW (OUT).

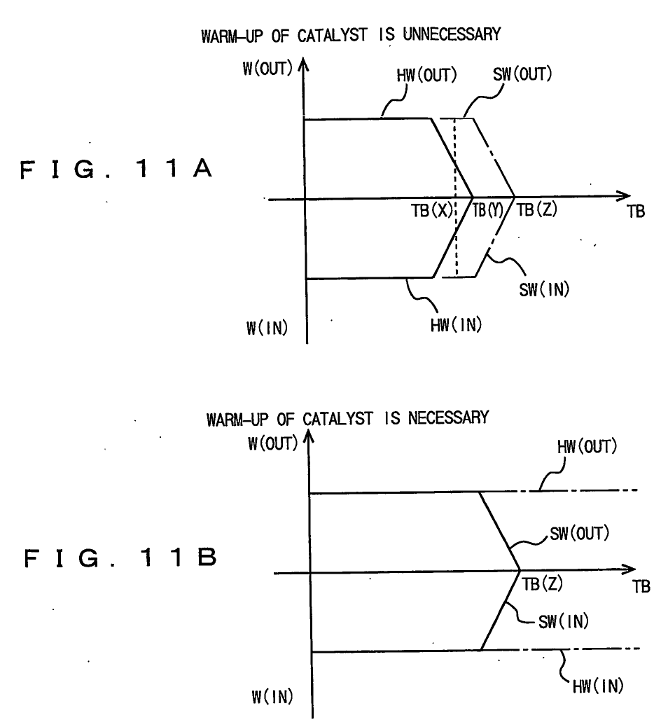

Referring back to FIG. 7, a detailed description is given of W (IN) and W (OUT) that are set in S900. W (IN) and W (OUT) in a case where warm-up of catalyst 116 is necessary are, as compared with those in a case where warm-up of the catalyst 116 is unnecessary, any values that relax the limitation on the charge/discharge electric power of battery 110 with respect to battery temperature TB. In other words, if warm-up of catalyst 116 is necessary, W (IN) and W (OUT) are set in such a manner that permits charging/discharging of battery 110 even if battery temperature TB is a relatively high temperature, as compared with W (IN) and W (OUT) in a case where warm-up of the catalyst is unnecessary. The above operations are described now with reference to FIGS. 11A and 11B respectively performed in the case where warm-up of catalyst 116 is unnecessary and the case where warm-up of catalyst 116 is necessary.

[A Case where Warm-up of Catalyst 116 is Unnecessary]

FIG. 11A shows SW (IN), SW (OUT), HW (IN) and HW (OUT) provided that warm-up of catalyst 116 is unnecessary and battery voltage value V is V (X). SW (IN) and SW (OUT) are calculated based on battery voltage value V and battery temperature TB regardless of the state of catalyst 116 (S620). If warm-up of catalyst 116 is unnecessary, namely catalyst temperature TC is higher than catalyst warm-up temperature TC (0) and the catalyst warm-up flag is reset, HW (IN) and HW (OUT) are also calculated based on battery voltage value V and battery temperature TB (S850). SW (IN), SW (OUT), HW (IN) and HW (OUT) are thus calculated as shown in FIG. 11A. Here, from a comparison between SW (IN) and HW (IN) on the condition that battery temperature TB is TB (X), it is seen that HW (IN) is larger (and accordingly limits the charge electric-power of battery 110). Then, when W (IN) is to be set, HW (IN) is selected in preference to SW (IN). Similarly, from a comparison between SW (OUT) and HW (OUT), it is seen that HW (OUT) is smaller (and accordingly limits the discharge electric power of battery 110). Then, when W (OUT) is to be set, HW (OUT) is selected in preference to SW (OUT). When battery temperature TB reaches at least TB (Y), W (IN) and W (OUT) are zero so that the charge/discharge electric power is limited to stop charging/discharging of battery 110.

[A Case where Warm-up of Catalyst 116 is Necessary]

FIG. 11B shows SW (IN), SW (OUT), HW (IN) and HW (OUT) provided that warm-up of catalyst 116 is necessary and battery voltage value V is V (X). SW (IN) and SW (OUT) are calculated based on battery voltage value V and battery temperature TB regardless of the state of catalyst 116 (S620). Further, if warm-up of catalyst 116 is necessary, namely catalyst temperature TC is equal to or lower than catalyst warm-up temperature TC (0) and the catalyst warm-up flag is set, ηW (IN) is calculated, with battery temperature TB fixed at fixed value TB (0) (S720), based on fixed value TB (0) and remaining battery capacity RAHR (S730). Thus, ηW (IN) does not limit the charge/discharge electric power of battery 110 with respect to battery temperature TB.

Moreover, HW (IN) and HW (OUT) are calculated based on only battery temperature increment ATB without relying on battery temperature TB (S840). HW (IN) and HW (OUT) do not limit the charge/discharge electric power of battery 110 with respect to battery temperature TB as indicated by the chain line in FIG. 11B. SW (IN), SW (OUT), HW (IN) and HW (OUT) are thus calculated as shown in FIG. 11B.

Accordingly, with respect to battery temperature TB, W (IN) and W (OUT) are set to respective values defined by SW (IN) and SW (OUT). When the battery voltage TB reaches TB (Z) which is higher than TB (Y), W (IN) and W (OUT) are zero to limit the charge/discharge electric power and thereby stop charging/discharging of battery 110.

As shown in FIGS. 11A and 11B, W (IN) and W (OUT) are set, in a case where warm-up of catalyst 116 is necessary, in a manner that charging/discharging of battery 110 is permitted even if battery temperature TB is relatively high as compared with the case where the warm-up is unnecessary. In this way, hybrid ECU 112 relaxes the limitation on the charge/discharge electric power with respect to battery temperature TB to expand the temperature region where charging/discharging of battery 110 can be done (in particular, the temperature region where discharging can be done). Thus, with battery 110 being at a high temperature, motor generator 102 can be driven.

Therefore, even if heat is generated due to charging/discharging of electric power of battery 110 so that a temperature is reached that is a level to inhibit charging/discharging in a normal state, motor generator 102 can be driven continuously if warm-up of catalyst 116 is necessary. In other words, if it is determined that warm-up of catalyst 116 is necessary and an acceleration request is made from the vehicle, hybrid ECU 112 controls the charge/discharge electric power of battery so that the vehicle is driven by motor generator 102 or a combination of engine 100 and motor generator 102.

Operations of the battery control device in this embodiment having the above-described structure and based on the above-described flowcharts are described respectively for the case where warm-up of catalyst 116 is unnecessary (catalyst temperature TC is higher than catalyst warm-up temperature (0)) and the case where warm-up of catalyst 116 is necessary (catalyst temperature TC is equal to or lower than catalyst warm-up temperature TC (0)).

[A Case where Warm-up of Catalyst 116 is Unnecessary]

A driver turns the ignition switch to the start position (YES in S100) to do initialization and set the warm-up priority flag (S200). Then, battery temperature TB is detected and the detected battery temperature TB is stored as initial battery temperature TB (1) (S250). Catalyst temperature TC is thereafter detected (S300). Here, as catalyst temperature TC is higher than catalyst warm-up temperature TC (0) (NO in S400), the catalyst warm-up flag is reset (S500) and thereafter the subroutine for calculating SW (IN) and SW (OUT) is executed (S600).

Through the subroutine for calculating SW (IN) and SW (OUT), battery voltage V and battery temperature TB (2) are first detected (S610). After this, based on the detected battery voltage V and battery temperature TB (2), SW (IN) and SW (OUT) are calculated (S620).

After SW (IN) and SW (OUT) are calculated (S620), the subroutine for calculating ηW (IN) is carried out (S700). Through the subroutine for calculating ηW (IN), remaining battery capacity RAHR and battery temperature TB (3) are detected (S705). Here, as the warm-up priority flag is reset in S500 (NO in S710), ηW (IN) is calculated based on remaining battery capacity RAHR and battery temperature TB (3) that are detected in S705 (S730).

After ηW (IN) is calculated (S730), the subroutine for calculating HW (IN) and HW (OUT) is carried out (S800). Through the subroutine for calculating HW (IN) and HW (OUT), battery voltage V and battery temperature TB (4) are detected (S810). Here, as the warm-up priority flag is reset in S500 (NO in S820), HW (IN) and HW (OUT) are calculated based on battery voltage V and battery temperature TB (4) that are detected in S810 (S850).

When the calculations of SW (IN), SW (OUT), ηW (IN), HW (IN) and HW (OUT) are completed, the maximum one of SW (IN), ηW (IN) and HW (IN) is set to W (IN) while the minimum one of SW (OUT) and HW (OUT) is set to W (OUT) (S900).

As shown in FIG. 11A, in setting W (IN), priority is given to HW (IN) over SW (OUT). Further, in setting W (OUT), priority is given to HW (OUT) over SW (OUT).

After W (IN) and W (OUT) are set (S900), the step-on amount of accelerator pedal 128 is detected (S910), and engine 100, motor generator 102 and inverter 106 operate according to the detected step-on amount so that the charge/discharge electric power level of battery 110 does not exceed W (IN) and W (OUT).

It is thereafter determined whether or not the ignition switch is turned off (S1000). If the ignition switch is turned off (YES in S1000), this process is completed. If not (NO in S1000), operations in and after S300 of detecting catalyst temperature TC are repeated.

[A Case where Warm-up of Catalyst 116 is Necessary]

Step S300 and its preceding steps are common to both this case and the above-described case where warm-up of catalyst 116 is unnecessary and thus the description thereof is not repeated here and step S400 and subsequent steps are now described.

As catalyst temperature TC is at most catalyst warm-up temperature TC (0) (YES in S400), the warm-up priority flag is still set while the subroutine for calculating SW (IN) and SW (OUT) is executed (S600).

Through the subroutine for calculating SW (IN) and SW (OUT), battery voltage V and battery temperature TB (2) are first detected (S610). Then, based on the detected battery voltage V and battery temperature TB (2), SW (IN) and SW (OUT) are calculated (S620).

After SW (IN) and SW (OUT) are calculated (S620), the subroutine for calculating ηW (IN) is performed (S700). Through the subroutine for calculating ηW (IN), remaining battery capacity RABR and battery temperature TB (3) are detected (S705). Here, as the warm-up priority flag is still set (YES in S710), battery temperature TB is fixed at predetermined fixed value TB (0) (S720), and ηW (IN) is calculated based on remaining battery capacity RAHR and fixed value TB (0) (S730).

After ηW (IN) is calculated (S730), the subroutine for calculating HW (IN) and HW (OUT) is executed (S800). Through the subroutine for calculating HW (IN) and HW (OUT), battery voltage V and battery temperature TB (4) are detected (S810). Here, as the warm-up priority flag is still set (YES in S820), battery temperature increment ΔTB is calculated from the difference between battery temperature TB (4) detected in S810 and initial battery temperature TB (1) stored in S250 (S830). After this, based on battery temperature increment ΔTB, HW (IN) and HW (OUT) are calculated (S840).

After respective calculations of SW (IN), SW (OUT), ηW (N), HW (IN) and HW (OUT) are completed, the maximum one of SW (IN), ηW (IN) and HW (IN) is set to W (IN) while the minimum one of SW (OUT) and HW (OUT) is set to W (OUT) (S900).

At this time, as shown in FIG. 11B, W (IN) and W (OUT) are set to respective values defined by SW (IN) and SW (OUT) with respect to battery temperature TB. In other words, if warm-up of catalyst 116 is necessary, charging/discharging of battery 110, particularly discharging of battery 110 is permitted even if battery 110 attains a higher temperature as compared with that in the case where warm-up of catalyst 116 is unnecessary. Thus, motor generator 102 functions as a motor driven with the electric power discharged from battery 110. In other words, when an acceleration request is made while the catalyst is being warmed up, the charge/discharge electric power of battery 110 is controlled in a manner that the vehicle is driven by motor generator 102.

After W (IN) and W (OUT) are set (S900), the step-on amount of accelerator pedal 128 is detected (S910), and engine 100, motor generator 102 and inverter 106 operate (S920) according to the detected step-on amount so that the charge/discharge electric power of battery 110 does not exceed W (IN) and W (OUT).

It is noted here that, in this embodiment, hybrid ECU 112 sets, in the case where warm-up is necessary, W (IN) and W (OUT) in a manner that motor generator 102 is driven even if battery 110 has a temperature higher than that in the case where the warm-up is unnecessary. Hybrid ECU 112, however, may allow motor generator 102 to be driven even if battery 110 has a lower temperature.

As heretofore discussed, with the battery control device of this embodiment, the limitation on the charge/discharge electric power with respect to battery temperature TB are relaxed, in the case where warm-up of the catalyst is necessary, so as to permit charging/discharging of the battery even if battery temperature TB attains a higher temperature as compared with that in the case where the warm-up is unnecessary. Accordingly, the hybrid ECU expands, in the case where warm-up is required, the temperature region which permits charging/discharging, particularly discharging of the battery, as compared with that in the case where warm-up is unnecessary. Then, the motor generator can be driven as a motor with the electric power discharged from the battery even if the battery has a higher temperature. When the catalyst is being warmed up, the hybrid ECU gives priority to driving of the motor generator as a motor over an increase in load due to excessive charging/discharging when the battery attains a higher temperature, so as to assist the engine and thereby accelerate the vehicle with the motor generator. Then, if an acceleration request is given while the catalyst is being warmed up, the hybrid ECU prevents the output of the engine from increasing to exceed an output level which is necessary for warming-up the catalyst and thus emissions of exhaust gas of an amount larger than the amount which can be purified by the catalyst in warm-up can be avoided.

Although the present invention has been described and illustrated in detail, it is clearly understood that the same is by way of illustration and example only and is not to be taken by way of limitation, the spirit and scope of the present invention being limited only by the terms of the appended claims.

1. A control device for a battery mounted on a vehicle having an engine generating a driving force by combustion of fuel, a catalyst purifying exhaust gas generated by the combustion, an electric motor generating a driving force, and the battery supplying electric power to said electric motor, said vehicle running by at least one of respective driving forces from said engine (and said electric motor, said control device comprising:
acceleration request detection means for detecting an acceleration request of said vehicle;
determination means for determining whether or not warm-up for increasing the temperature of said catalyst is necessary; and
control means for controlling, in a case where said determination means determines that said warm-up is necessary and said acceleration request is detected, charge/discharge electric power of said battery to drive said vehicle by said electric motor.

2. The control device for the battery mounted on the vehicle according to claim 1, wherein
said control means includes
limitation means for limiting the charge/discharge electric power of said battery, and
relaxation means for relaxing, if said determination means determines that said warm-up is necessary, limitation on said charge/discharge electric power as compared with limitation on said charge/discharge electric power in a case where said warm-up is unnecessary.

3. The control device for the battery mounted on the vehicle according to claim 2, further comprising temperature detection means for detecting the temperature of said battery, wherein
said limitation means includes means for limiting said charge/discharge electric power based on the detected temperature.

4. The control device for the battery mounted on the vehicle according to claim 3, wherein
said relaxation means includes means for relaxing the limitation on said charge/discharge electric power based on the battery temperature if it is determined that said warm-up is necessary.

5. The control device for the battery mounted on the vehicle according to claim 2, wherein
said relaxation means includes means for relaxing the limitation on said charge/discharge electric power based on the battery temperature if it is determined that said warm-up is necessary.

6. The control device for the battery mounted on the vehicle according to claim 2, further comprising increment detection means for detecting an increment in temperature of said battery, wherein
said limitation means includes means for limiting said charge/discharge electric power based on the detected increment.

7. A control device for a battery mounted on a vehicle having an engine generating a driving force by combustion of fuel, a catalyst purifying exhaust gas generated by the combustion, an electric motor generating a driving force, and the battery supplying electric power to said electric motor, said vehicle running by at least one of respective driving forces from said engine and said electric motor, said control device comprising:
an acceleration request detection unit for detecting an acceleration request of said vehicle;
a determination unit for determining whether or not warm-up for increasing the temperature of said catalyst is necessary; and
a control unit for controlling, in a case where said determination unit determines that said warm-up is necessary and said acceleration request is detected, charge/discharge electric power of said battery to drive said vehicle by said electric motor.

8. The control device for the battery mounted on the vehicle according to claim 7, wherein
said control unit includes
a limitation unit for limiting the charge/discharge electric power of said battery, and
a relaxation unit for relaxing, if said determination unit determines that said warm-up is necessary, limitation on said charge/discharge electric power as compared with limitation on said charge/discharge electric power in a case where said warm-up is unnecessary.

9. The control device for the battery mounted on the vehicle according to claim 8, further comprising a temperature detection unit for detecting the temperature of said battery, wherein
said limitation unit limits said charge/discharge electric power based on the detected temperature.

10. The control device for the battery mounted on the vehicle according to claim 9, wherein
said relaxation unit relaxes the limitation on said charge/discharge electric power based on the battery temperature if it is determined that said warm-up is necessary.

11. The control device for the battery mounted on the vehicle according to claim 8, wherein
said relaxation unit relaxes the limitation on said charge/discharge electric power based on the battery temperature if it is determined that said warm-up is necessary.

12. The control device for the battery mounted on the vehicle according to claim 8, further comprising an increment detection unit for detecting an increment in temperature of said battery, wherein
said limitation unit limits said charge/discharge electric power based on the detected increment.

13. A control method for a battery mounted on a vehicle having an engine generating a driving force by combustion of fuel, a catalyst purifying exhaust gas generated by the combustion, an electric motor generating a driving force, and the battery supplying electric power to said electric motor, said vehicle running by at least one of respective driving forces from said engine and said electric motor, said battery control method comprising the steps of:
detecting an acceleration request of said vehicle;
determining whether or not warm-up for increasing the temperature of said catalyst is necessary; and
controlling, in a case where it is determined that said warm-up is necessary and said acceleration request is detected, charge/discharge electric power of said battery to drive said vehicle by said electric motor.

14. The control method for the battery mounted on the vehicle according to claim 13, wherein
said step of controlling charge/discharge electric power includes the steps of
limiting the charge/discharge electric power of said battery, and
relaxing, if it is determined that said warm-up is necessary in said step of determining whether or not warm-up is necessary, limitation on said charge/discharge electric power as compared with limitation on said charge/discharge electric power in a case where said warm-up is unnecessary.

15. The control method for the battery mounted on the vehicle according to claim 14, further comprising the step of detecting the temperature of said battery, wherein
said step of limiting the charge/discharge electric power includes the step of limiting said charge/discharge electric power based on the detected temperature.

16. The control method for the battery mounted on the vehicle according to claim 15, wherein
said step of relaxing limitation includes the step of relaxing the limitation on said charge/discharge electric power based on the battery temperature if it is determined that said warm-up is necessary.

17. The control method for the battery mounted on the vehicle according to claim 14, wherein
said step of relaxing limitation includes the step of relaxing the limitation on said charge/discharge electric power based on the battery temperature if it is determined that said warm-up is necessary.

18. The control method for the battery mounted on the vehicle according to claim 14, further comprising the step of detecting an increment in temperature of said battery, wherein
said step of limiting said charge/discharge electric power includes the step of limiting said charge/discharge electric power based on the detected increment.
